(19) United States
(12) Patent Application Publication
(10) Pub. No.: US 2002/0048642 A1
(43) Pub. Date: Apr. 25, 2002

(54) Production of crystallizable polymer blow molded containers having a crystallized interior

(76) Inventor: Martin H. Beck, Amherst, NH (US)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/935,912

(22) Filed: Aug. 23, 2001

Related U.S. Application Data
(60) Provisional application No. 60/230,674, filed on Sep. 7, 2000.

(51) Int. Cl. B32B 1/02; B29C 49/12; B29C 49/16

(52) U.S. Cl. 428/35.7; 264/521; 264/529; 264/532

(57) ABSTRACT

A method to blow mold a crystallizable polymer container having an interior surface, comprising using a heated blowing fluid in conjunction with a single cool blow mold cavity to produce a container having a crystallized interior surface or in conjunction with hot blow mold cavity to produce a container having crystalized interior and exterior surfaces; and two stage blow molding using two separate blow molds used sequentially also contemplated to produce similar results.

This patent application relates to a novel method of blow molding crystallizable polymer containers, applying heated or cooled fluid to preheated preforms to produce finished molded containers with crystallization (heat set) of the inner section adjacent the interior wall equal to or greater than that of the exterior outer section adjacent the exterior wall of the container, and improved dimensional stability.

As used herein a crystallizable polymer shall be construed to mean a polymer which can be crystallized, oriented and blow molded.

### BACKGROUND OF THE INVENTION

Presently, crystallizable polymer, typically polyethylene terephthalate (i.e. PET) blow molded containers which are to be used in hot fill applications (e.g. filled with product at temperatures greater than 125° F.) and then cooled are blown by forming a container preform in an injection or similar mold, preheating the preform, inserting the preheated preform into a multi-section, preheated blow mold, stretching the preform longitudinally for the length of the blow mold using a stretch rod, and forming the container final shape by injecting cooled air under pressure into the interior of the preform, which inflates the preheated preform to conform to the interior shape of the blow mold. The surface of the blow mold which the plastic contacts is normally between about 180° F. and 350° F. for the heat set process. The amount of time the exterior surface is in contact with the hot surface of the blow mold will determine the level crystallinity formed. The time is generally between 0.1 to 2 seconds for standard processes. However, additional time may be used at a productivity loss. Most of the crystallization of the container wall occurs on the exterior surface of the container, from both the preform preheating and contact with the heated blow mold. The higher the percentage of crystals, the more thermally stable the PET container will be. Other crystallizable polymers that have crystallization characteristics can also be used in this invention.

In the known blow molding methods, the blowing air or fluid may even be supercooled by the use of liquid nitrogen, etc. A cooled fluid such as air is used to solidify the container and control the final dimensions of the container prior to removal from the blow mold. Blow molds are typically manufactured in multiple sections to permit ease of container removal by opening of the mold following container cooling. The surface temperature of the blow mold is also limited by the predisposition of the blown containers to shrink upon removal from the mold before they can be cooled sufficiently to stabilize. This results from excessive residual heat retained in the container, upon completion of blowing. Using current methods, multiple containers are formed simultaneously using multiple molds and preforms.

The known blow molding methods have used three blowing stages, the first stage of which is called a pre-blow or low pressure blow stage. In the first stage, relatively low pressure is used to blow the preform into a basic or intermediate shape which may or may not touch the blow mold itself and which may not produce the final details of the container. This first stage is followed by a second stage, high pressure blow, in which cooled high pressure air or other fluid expands the intermediate shape against the hot blow mold surface to allow crystals to grow in the PET sidewalls. The third stage allows the high pressure air to circulate to cool the interior walls to resist container shrinkage.

A second type of blow molding, known as the double blow method, uses two molds and two stages of preheating. In this method, a first preform preheat is conducted, the preheated preform is inserted in a first cooled mold, and a first stage blow forms an intermediate container or “limp bag”. The “limp bag” is then reheated and placed in the second or final container shaped blow mold, and a second blowing stage is used to generate the final container shape. This method imparts greater crystallization, however, it is very difficult to control the material distribution as the “limp bag” distorts non-uniformly upon blowing. This type of blow molding has therefore been largely abandoned.

The amount of thermally induced crystalline growth is a function of several variables, with two specifically being time (t) and temperature (T). For PET, the fastest rate of crystallization (heat setting) occurs at a temperature of approximately 350° F. The curve showing this is a Bell curve with the peak at approximately 350° F. Use of this approximate temperature leads to minimal mold cycle times. The majority of PET crystallization occurs at the container surface exposed to temperatures in the crystallization range. In the current art processes, the majority of crystallization occurs at the outer section of the container wall with little to no crystallization occurring in the inner wall section. The middle wall section has less that the outer but more than the inner wall section.

### OBJECT OF THE INVENTION

A primary object of the invention is to increase crystallization on the interior surface of the container, by providing heated blowing fluid to the preform interior space during the blowing stages.

A further object of the invention is to minimize the effect of retained blow mold residual heat by pre-cooling the mold, and using heated fluid to provide the blowing force. This combination allows the container to dimensionally set and cool against the mold inner walls more quickly, decreasing subsequent container dimensional instability from prolonged contact with a heated blow mold, thus providing more consistent finished container dimensions.

A further object of the invention is to provide crystallization of both the interior and exterior surfaces of a blow molded PET container. The creation of two levels of crystallization will yield different container properties.

A further object of the invention is to provide crystallization of both interior and exterior section of a multilayered blow mold container whereby the “B” (barrier) materials located within the middle wall sections are less impacted by the thermal energy.

### SUMMARY OF THE INVENTION

According to one aspect of the invention, a relatively hot fluid inflates a preheated preform in a relatively cool blow mold with internal geometry corresponding to the desired finished container. Preferably the molding surface of the blow mold is held at or below about 80° F., more preferably between about 35° F. and about 55° F. Cooling tubes or other means for maintaining the desired temperature, or even lower temperatures of the mold, may be provided in the mold structure. The preform is preheated to a temperature between about 180° F. and about 260° F.

The temperature conditioned preform is then inserted into the blow mold, a stretch rod, already known in the art, is usually employed to longitudinally stretch the preform to the opposite end of the blow mold. Optionally, hot gaseous fluid is injected into the preform through an annular clearance remaining between the stretch rod and the circular opening to the preform, or through holes provided in a hollow stretch rod. The temperature of the gaseous fluid is preferably about 350° F. upon first contact with the preheated preform. The stretch rod may stretch the preform until the preform base contacts the blow mold base. The preform is then expanded to conform to the blow mold by the force of the heated fluid injection pressure, crystallizing the interior surface of the container material due to the elevated temperature of the injected fluid. If this stage of blow sufficiently brings the preform into complete conformity with the blow mold inner walls, the blow molding is complete when the finished container shape sufficiently cools from contact with the cooled blow mold walls to be removed from the blow mold. If this (first) stage does not complete container expansion and formation, a second blow stage may be employed. In such a second stage, a similar high temperature fluid, typically at higher pressure, is injected into the intermediate shape to expand the intermediate shape to conform to the blow mold interior walls, and hold the container in position against the blow mold inner walls, until sufficient cooling of the container from contact with the cooler blow mold has occurred, to allow removal of the container from the blow mold. Cooling times will vary with container material, shape, and wall thickness, as well as blow mold temperature, and other known parameters.

The inventive method produces a finished container with increased interior wall crystallization. Higher temperature conditioning of the preform interior results in an initially greater degree of crystallization on the interior wall of the container than on the exterior wall of the container. Pressure of the individual stage blowing fluids may be varied from low to high pressure consistent with the requirements of the individual preform, blow mold, and container parameters. Crystallization of the container interior surface from use of the invention method differs from the prior art method, wherein no crystallization of the interior surface occurred.

The invention provides a method for blow molding a crystallizable polymer (i.e. a polyester such as PET) container having an interior surface, comprising the steps of: providing a preform for blow molding a container; providing a blow mold defining an molding surface having a desired temperature; preheating the preform; inserting the preheated preform into the blow mold; injecting, in a first stage, a fluid at a desired temperature into the preform, at a pressure to expand the preform; and subsequently injecting, in a second stage, a fluid at a desired temperature into the expanded preform, at a pressure to expand the preform to conform to the blow mold molding surface, to produce said container; wherein at least one of said first stage and said second stage produce crystallization of an inner section adjacent to the interior surface of the container.

The invention also provides a method for blow molding a crystallizable polymer container having an interior surface, comprising the steps of: providing a preform for blow molding a container; providing a first blow mold defining an molding surface having a desired temperature; preheating the preform; inserting the preheated preform into the first blow mold; injecting, in a first stage, a fluid at a desired temperature into the preform, at a pressure to dispose an intermediate article; removing the intermediate article from the first blow mold; preheating the intermediate article; providing a second blow mold defining an interior surface having a desired temperature; inserting the intermediate article into the second blow mold; injecting, in a second stage, a fluid at a desired temperature into the intermediate article, at a pressure to expand the intermediate article to conform to the blow mold interior surface, to produce said container; wherein at least one of said first stage and said second stage produce crystallization of an inner section of the container adjacent to the interior surface of the container.

The above methods provide a crystallizable polymer blow molded container having at least a crystallized inner section adjacent an inner surface of the container made by an above method of the present invention

The invention also provides a method of blow molding, in a blow mold having a molding surface, a crystallizable polymer to form a container having an outer section including an outer surface which contacts the molding surface, an inner section including an inner surface which during blow molding is contacted by pressurized gaseous fluid and a middle section intermediate the inner and outer sections, comprising the steps of: providing a preform of the crystallizable polymer for blow molding the container; providing the blow mold defining molding surface having a desired temperature; preheating the preform; inserting the preform into the blow mold; and injecting a pressurized gaseous fluid under pressure into the preform to expand the preform into contact with the molding surface, the temperature of the molding surface and the fluid being chosen to crystallize at least one of the inner and out sections; wherein the temperatures of the molding surface, the fluid and residence time are chosen to provide a desired variation of crystallization through the inner, middle, and outer sections.

This latter method can provide, by choosing the temperatures of the molding surface, the fluid and the residence time, lower crystallinity in the middle section than in the inner and outer sections or crystallization of the outer section which is higher than the inner section which in turn is higher that the middle section.

The invention also can provide a container having a dual level of crystallinity where the dual of crystallinity provides improved characteristics and performance of the container. Such improvements include better resistance to gas permeation from outside the container. An example is oxygen permeation which will spoil many food or beverage products. Another example is the retention of carbon dioxide within carbonated soft drink containers or beer products.

Further, the interior level of crystallinity provides better resistance to scalping (absorption) of flavors or other items from food or beverages.

The interior level of crystallinity also provides more resistance to deformation when exposed to hot product upon filling.

In addition, the duality of crystalline regions in the container wall provides better performance in the container than a container with a same average but uniform level of crystallinity. The two higher levels of crystallinity sandwich the lower level of crystallinity thus giving the container unique advantages due to different molecular structures in the layers as well as transitional zones which provide a mix of both high and low levels of crystallinity. The different molecular structures give different properties to the container. Some of the high crystallinity properties were sectioned. A lower level crystallinity advantage is that it is less brittle so breakage due to impact is reduced.

### BRIEF DESCRIPTION OF THE DRAWINGS

The present invention will now be described, by way of example, with reference to the accompanying drawings, in which:

FIG. 1 is a sectional elevation of a preform showing a prior art neck finish and wall thicknesses;

FIG. 2 is a sectioned elevation of a prior art preform and stretch rod, positioned within a fragmentary cross-section of the blow mold, shown prior to the blowing stage(s);

FIG. 3 is a partial side elevation of the stretch rod and preform after extension of both also showing a bottom portion of a typical prior art finished container for reference;

FIG. 4 is a sectional elevation of a prior art finished container;

FIG. 5 is a flow diagram of the preferred embodiment of the inventive process;

FIG. 6 is a flow diagram of a second embodiment of the inventive process which also uses two blowing stages in a single blow mold;

FIG. 7 is a flow diagram of a third embodiment using first and second blow molds;

FIG. 8 is a flow diagram of a fourth embodiment also using first and second blow molds;

FIG. 9 is a flow diagram of a fifth embodiment also using first and second blow molds; and

FIGS. 10, 11 and 12 are diagrammatic cross-sections of a wall portion of a finished container according to the present invention overlaid by a graphical representation of the distribution of the degree of crystallization through the thickness of the wall under various processing conditions.

### DESCRIPTION OF THE PREFERRED EMBODIMENTS

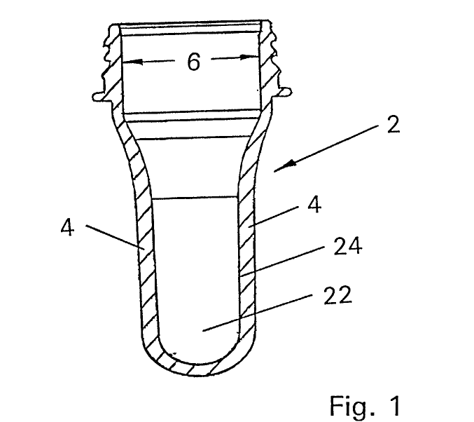

Referring to FIG. 1, a prior art preform 2 with walls 4 and circular neck opening 6, is preheated to a temperature range of about 180° F. to about 260° F. prior to being positioned into a blow mold. The neck finish and neck region of preform 2 are substantially unchanged by the blowing procedure. Temperature conditioning of the preform takes place outside the blow mold cavity immediately prior to the preform being positioned in the blow mold cavity. The production of preforms, and methods of temperature conditioning of preforms, are well known in the art, and are therefore not discussed in further detail herein.

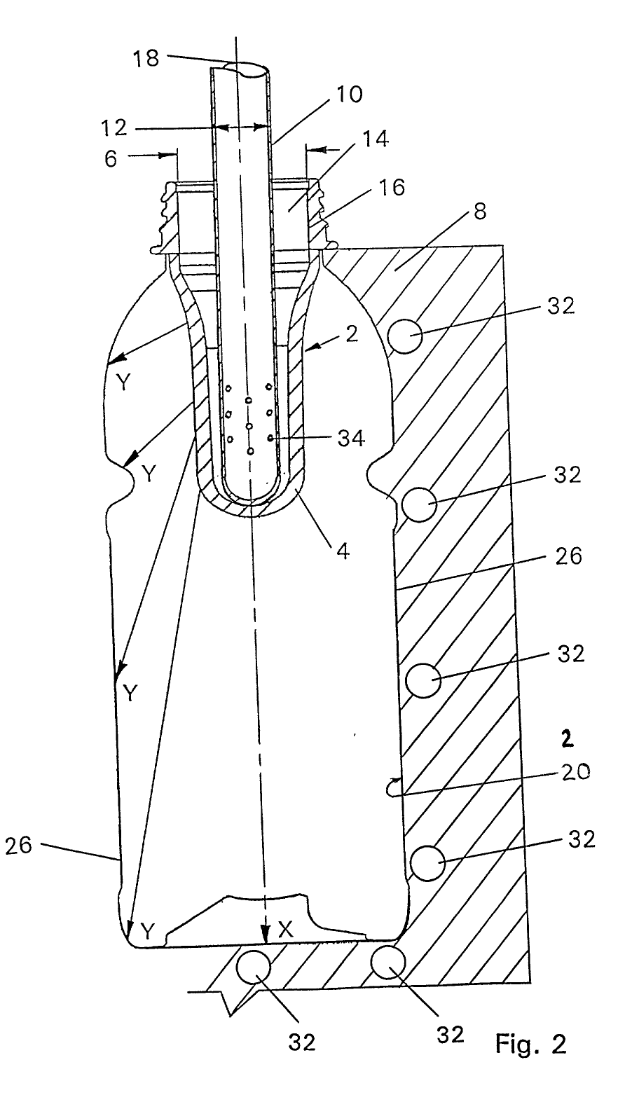

Referring to FIG. 2, the temperature conditioned preform 2 is then positioned in a precooled blow mold 8 (shown for clarity in FIG. 2 as only a portion of a full blow mold). Blow mold temperature is maintained below ambient, about 80° F., and preferably between about 35° F. and about 55° F. Examples of blow mold cooling equipment, as cooling coils 32, are shown adjacent the cavity of blow mold 8. A stretch rod 10 of diameter 12 is placed in neck opening 6 of preform 2, forming annular clearance 14 therewith. This clearance provides space for injection of a fluid into preform 2. Injection of the fluid into preform 2 may optionally be via holes 34 in stretch rod 10. The stretch rod 10 is extended along its longitudinal axis to longitudinally stretch preform 2 into blow mold 8 along longitudinal axis 18, in the direction shown by arrow X.

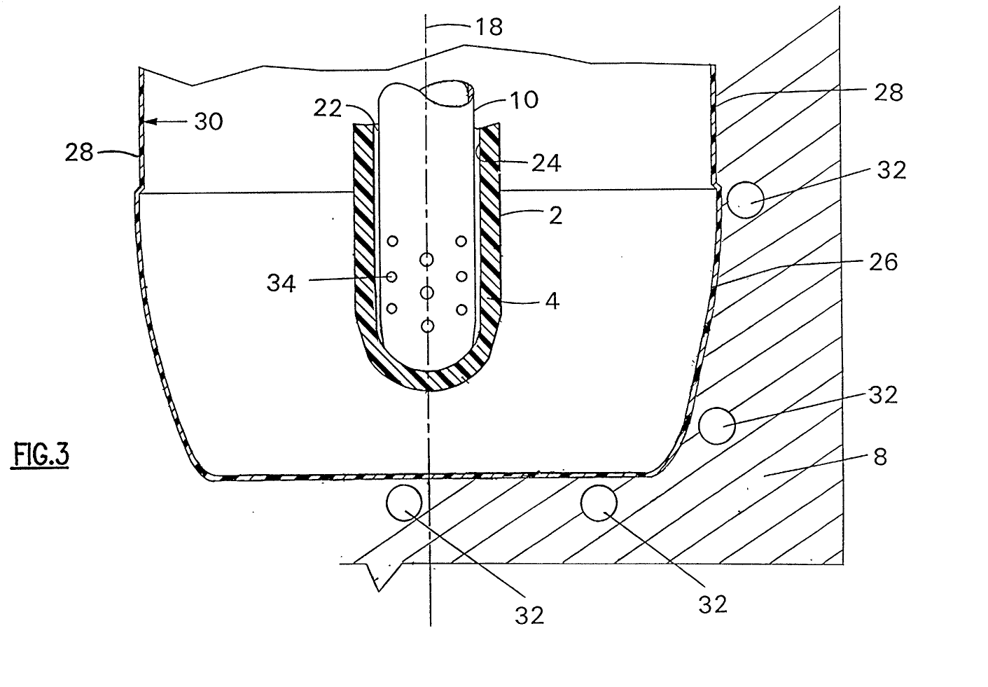

FIG. 3 shows stretch rod 10 and preform 2, after extension of stretch rod 10. As shown in FIG. 3, a clearance is normally maintained after extension of stretch rod 10, such that preform 2 does not contact the bottom of the blow mold cavity 20. Referring to both FIGS. 2 and 3, pressurized fluid, preferably in a gaseous form of air or steam, is then introduced within annular clearance 14 between the stretch rod 10 and annular wall 16 of the neck opening 6. The pressurized gaseous fluid expands the walls 4 of the preform 2 outward and downward, in the direction shown by arrows Y and X (FIG. 2), until the preform 2 contacts the cavity walls 20 of blow mold 8. Blowing and stretch rod extension may be simultaneous, sequential, or overlapping in time. Blow molding generally proceeds immediately from below the neck region of preform 2 to the base region of preform 2. Use of a stretch rod and the radial expansion of the preform, with subsequent controlled biaxial orientation of the finished container material resulting from the blow, are well known in the art, and are therefore not discussed in further detail herein.

The temperature of the cavity walls of the blow mold 8 is preferably controlled to a temperature below about 80° F. and most preferably to the range between about 35° F. to about 55° F., thus acting to cool the material of preform 2 when in contact with the cavity wall 20 of blow mold 8. Any suitable means, including, but not limited to such methods as circulating cold or super cold fluids (e.g. refrigerated air, nitrogen, Freon, etc.) may be employed to cool the blow mold 8. Temperatures below the preferred range stated above may also be used depending on the material blown, geometry of the article blown, desired cooling rate, or other variables.

Referring back to FIG. 1, during blowing of the preform 2, the fluid (e.g. air, steam, etc.) is introduced into the preform interior 22, so that it contacts the interior surface 24 of preform 2 at a fluid temperature of about 350° F. for PET, the temperature of the fluid closely matched to the specific polymer's fastest rate of crystallization. Due to thermal loss, this may mean that the high pressure gaseous fluid, when entering the blow mold structure upstream of neck opening 6 to the preform 2, may have to be at a temperature of about 450° F. or more. To produce crystallization (heat set) of interior surface 24, which is greater than crystallization of the container outer surface due to the cooled blow mold, the gaseous fluid contacting the interior surface 24 could be at a temperature as low as about 250° F., or as high as about 400° F., and is preferably in the range of about 300° F. to about 350° F. and more preferably at about 350° F.

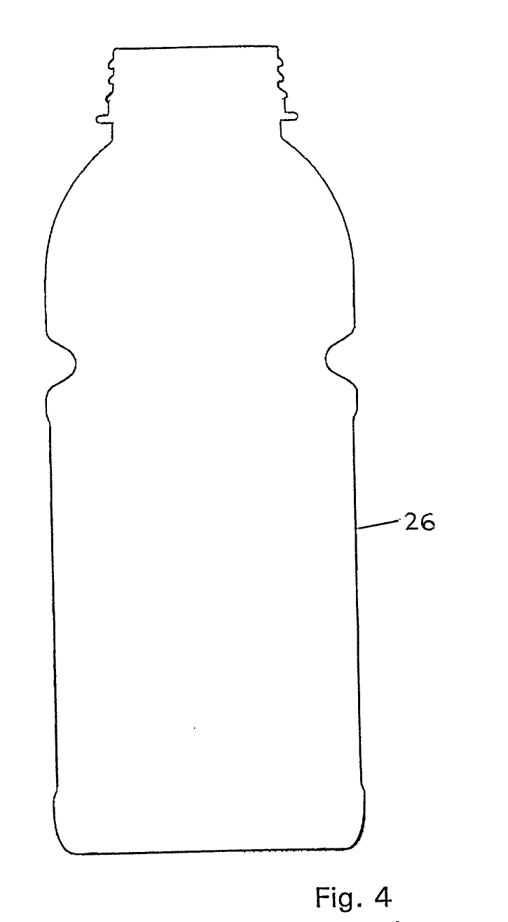

The finished container 26, shown as prior art in FIG. 4., is removed from blow mold 8, after sufficient cooling of the finished container walls 28 to ensure dimensional stability. The process can then be repeated for a new container. After blowing the container and crystallization of the interior surface, a cool or cold fluid may be injected into the container to speed cooling and stabilization of the container thereby to reduce cycle times.

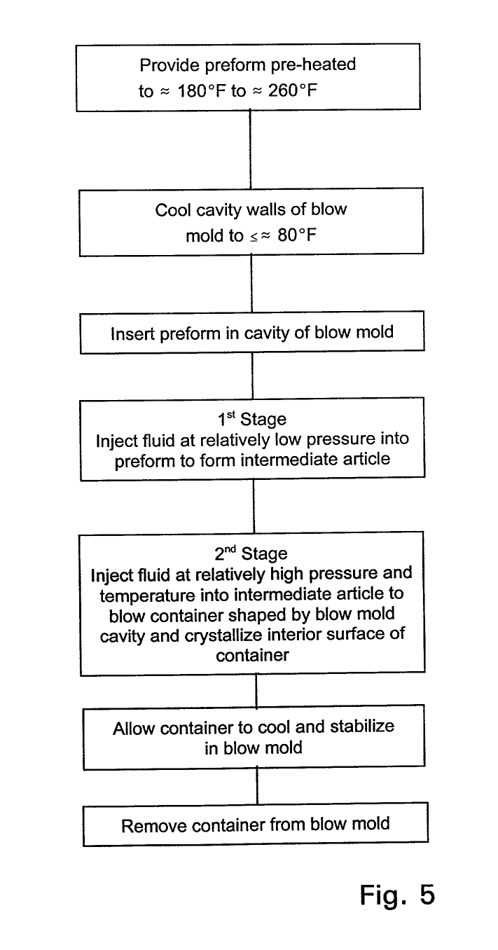

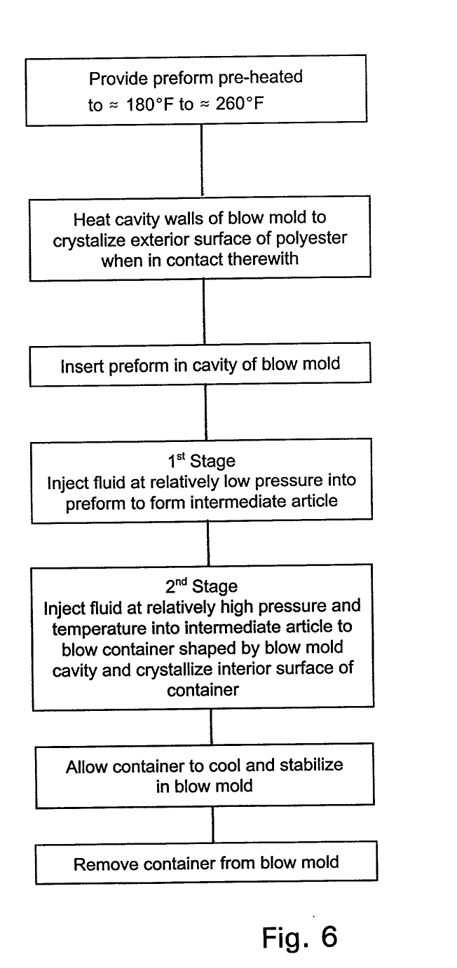

FIGS. 5 and 6 show a first and second embodiment of the invention, wherein a two stage process and a single blow mold is used, in which following a first stage relatively low pressure blow to form an intermediate article a second stage relatively high pressure blow is used at a temperature to blow the final form of the container with a crystallized interior surface.

In the second embodiment of the invention (FIG. 6), a single hot mold is used, together with a first stage, low pressure, hot blow, followed by a second stage, high pressure, cold blow. Crystallization of both the interior and exterior surfaces of the container is achieved by the use of a heated blow mold and the low pressure, hot blow.

In the following three embodiments, both the interior and exterior container surfaces are also crystallized.

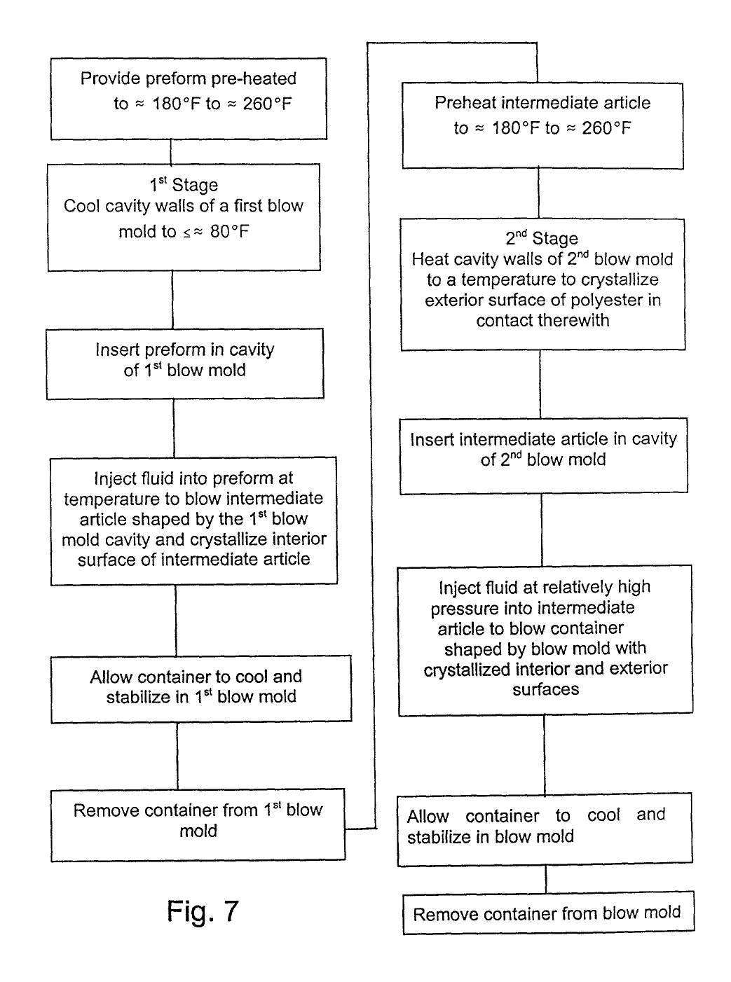

In a third embodiment of the invention, see FIG. 7, two blow molds are used. The first blow mold is cold to maintain an intermediate shape, and a heated fluid is used to crystallize (heat set) the interior walls of the intermediate shape. The second blow mold is heated to crystallize (heat set) the outer surface of the container with a cold fluid being used to blow the final shape of the container and to cool the container. The intermediate shape may be re-heated in between the two blow molding stages.

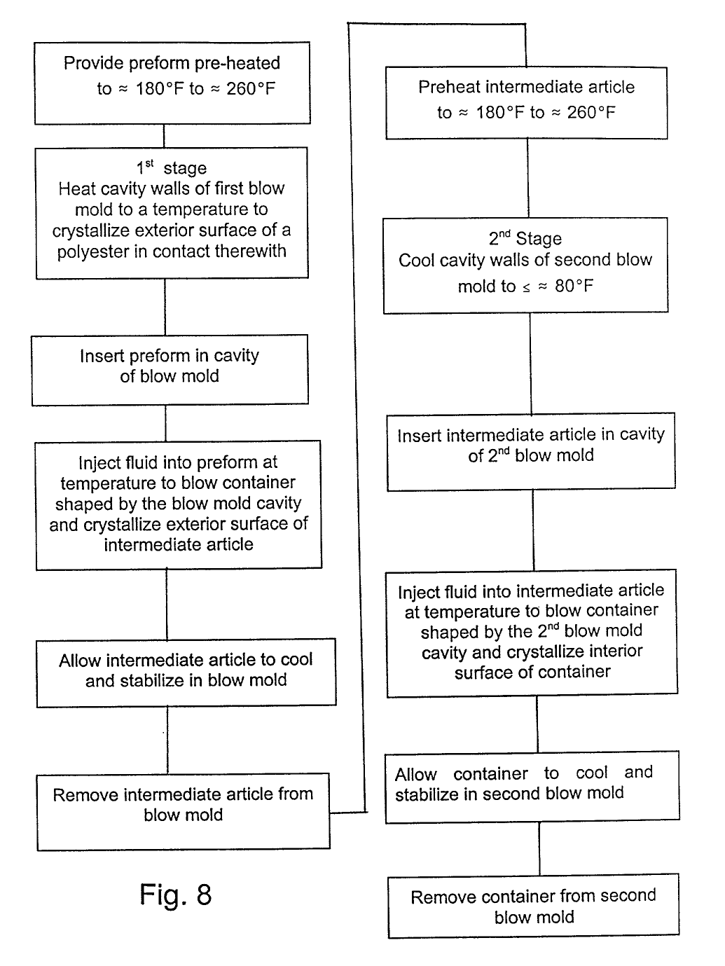

In a fourth embodiment of the invention, see FIG. 8, two blow molds are also used. The first blow mold is heated to heat set the outer container surface with a cooled fluid being used to blow the intermediate shape. A cooled blow mold with a heated fluid is then used to heat set the inner container walls and cool the exterior of the final shape of the container. The intermediate shape may be re-heated in between the two blow molding stages.

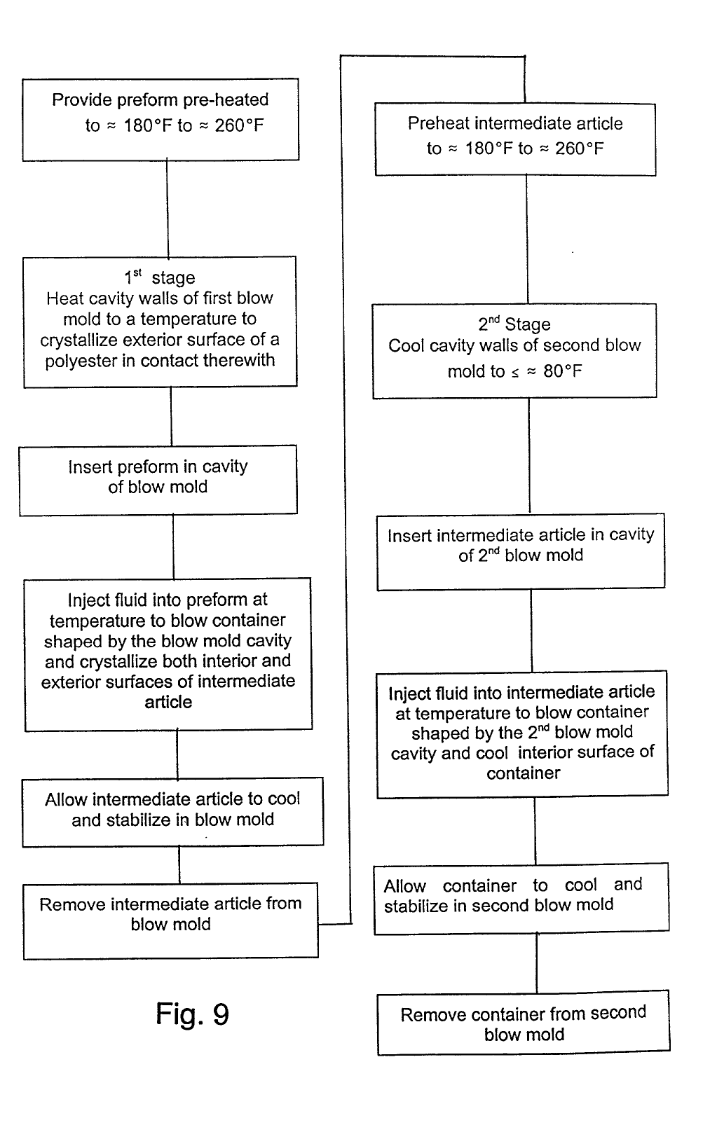

In a fifth embodiment of the invention, see FIG. 9, two molds are again used, again also producing an intermediate shape. In the first stage, the mold and the blowing fluid are both heated, crystallizing both inside and outside container walls simultaneously. The second stage mold and the blowing fluid are both cooled, to form the final container shape and cool the container. The intermediate shape may be re-heated in between the two blow molding stages.

The cool blow mold, in various embodiments, may be cooled to provide a cavity temperature lower than the 35° F. to 55° F. range identified as the preferred embodiment temperature of the cavity.

A single hot mold is employed for the final embodiments.

In a further embodiment of the invention, a single hot mold is used, together with a first stage low pressure, cold blow, followed by a second stage, high pressure, hot blow. Crystallization of both the interior and exterior surfaces of the container is achieved by the use of the heated blow mold and the high pressure, hot blow.

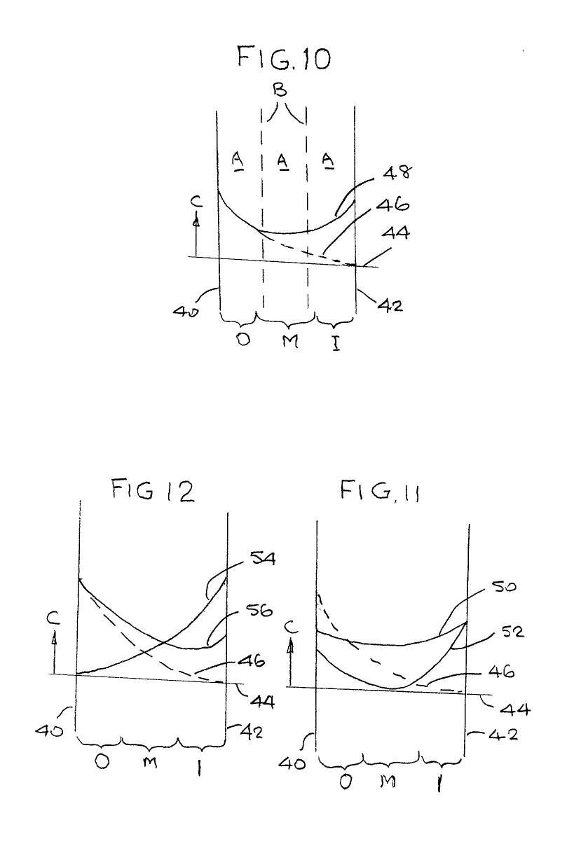

Referring now to FIG. 10 the wall of the container comprising a multilayer construction having materials A, B, A, B, A where A is a crystallizable polymer (i.e. PET) and B is a barrier material. The wall has an outer surface 40, bounding an outer section D, formed by the molding surface of the blow mold 8, an inner surface 42, bounding an inner section I, formed by the pressurized gaseous fluid. Defined by and located between the outer and inner section O and I is a middle or intermediate section M.

The overlying graph of crystallinity distribution through the thickness of the wall (O+M+I) comprises a base line 44 representing zero crystallization, an arrow C pointing in the direction of increasing degrees of crystallization, a dash line curve 46 representing prior art crystallization distribution resulting from blow molding in a hot blow mold molding surface using a cold or cool pressurized blowing gaseous fluid and a solid line curve 48 illustrating an example of the variation of crystallization distribution which may be achieved using a hot blow mold molding surface and a hot pressurized blowing gaseous fluid.

The distribution of crystallization through the container wall's inner, middle and outer sections is controlled by appropriate choice of molding surface and blowing fluid temperatures and selection of an appropriate residence time of the preform/container in the blow mold.

Producing 3 or 5 layer multilayer heat set containers by a normal heat set process is known in the industry. Producing a multilayer container with the duality of crystallinity of curve 48 is not known. There are advantages to this duality of crystallinity in that the middle section M also has the “B” material within it.

The type of “B” material will determine if it is desired to have more of less crystallinity in the middle section. Some B materials can crystallize too fast and may become cloudy or brittle when crystallized. This may have a negative effect on the quality of the container.

Further, some “B” materials will not bond to a highly crystallized material and will separate into distinct layers, this has a negative effect on the container.

On the other hand, some “B” materials will react favorably to the thermal energy of heat setting. Some “B” materials will crystallize and improve performance providing a better barrier and the like.

Overall, with the ability to control the levels of crystallinity separately or jointly between the 3 sections of the cross section of the wall is desirable. The final characteristics and performance of the PET container can be adjusted by manipulating the process conditions, so that the average level of crystallinity increases, middle section of crystallinity provides:

a) better resistance to gas permeation from outside (which will spoil product)

b) better resistance to scalping (absorption) of flavors or other items From food or beverage

Both FIGS. 11 and 12 illustrate monolayer wall portions in which similar elements have the same reference characters as used in FIG. 10. Although the sections of FIGS. 11 and 12 are monolayer the teaching of these figures also applies to multilayer constructions. FIGS. 11 and 12 illustrate the crystallinity distribution resulting from four examples of processing using the present invention:

First process curve 50 provides a higher average crystallinity throughout the wall thickness than the prior art using a hot molding surface and a hot fluid blow;

Second process curve 52 provides higher crystallinity, relative to the prior art, only in the inner section I by the use of a warm molding surface and a hot fluid blow (here the average crystallization is approximately the same as the prior art);

Third process curve 54 provides higher crystallinity only in the inner Section I, with substantially zero crystallinity at the outer surface 40 using a cold molding surface and a hot fluid blow; and

Fourth process curve 56 provides a skewed distribution of crystallinity with a higher crystallinity in the outer section O and a lesser crystallinity in the inner Section I by the use of a hot molding surface and a cool fluid blow in stage 1 (see FIG. 6) and a hot fluid blow in stage 2 (see FIG. 6).

The inventive method is amenable to prior art use of container reinforcing rings, inserts, petaloid bases and the multiple designs of container base types now used or that may be proposed in the art. It will be appreciated that the actual shape of the preform and container may differ from that shown herein providing the method set forth is followed.

### REFERENCE NUMERALS

| | |
|---|---|
| 2 preform | 40 outer surface |
| 4 preform walls | 42 inner surface |
| 6 neck opening | 44 base line |
| 8 blow mold | 46 dashed line curve |
| 10 stretch rod | 48 sold line curve |
| 12 stretch rod diameter | 50 first process |
| 14 annular clearance | 52 second process |
| 16 annular wall | 54 third process |
| 18 blow mold longitudinal axis | 56 fourth process |
| 20 blow mold cavity | C arrow |
| 22 preform interior | O outer section |
| 24 preform interior surface | I inner section |
| 26 finished container | M middle section |
| 28 finished container walls | X direction of stretch rod motion |
| 30 finished container inner surface | Y direction of preform expansion |
| 32 blow mold cooling coil | |
| 34 stretch rod holes | |

We claim:

1. A method for blow molding a crystallizable polymer container having an interior surface, comprising the steps of:
providing a preform for blow molding the container;
providing a blow mold defining a molding surface having a desired temperature;
preheating the preform;
inserting the preheated preform into the blow mold; and
injecting, in a first stage, a fluid at a desired temperature into the preform, at a pressure to expand the preform; and subsequently
injecting, in a second stage, a fluid at a desired temperature into the expanded preform, at a pressure to expand the preform to conform to the blow mold interior surface, to produce said container;
wherein at least one of said first stage and said second stage produce crystallization of an inner section of the container adjacent the interior surface.

2. The method of claim 1, further comprising the step of inserting a stretch rod into the preform to longitudinally stretch the preform in the blow mold.

3. The method of claim 2, further comprising the step of injecting said fluid via the stretch rod, the stretch rod further having a hollow interior for internal fluid flow; and a plurality of holes to disperse the fluid.

4. A method for blow molding a crystallizable polymer container having an interior surface, comprising the steps of:
providing a preform for blow molding a container;
providing a first blow mold defining an molding surface having a desired temperature;
preheating the preform;
inserting the preheated preform into the first blow mold;
injecting, in a first stage, a fluid at a desired temperature into the preform, at a pressure to dispose an intermediate article;
removing the intermediate article from the first blow mold;
preheating the intermediate article;
providing a second blow mold defining an interior surface having a desired temperature;
inserting the intermediate article into the second blow mold;
injecting, in a second stage, a fluid at a desired temperature into the intermediate article, at a pressure to expand the intermediate article to conform to the blow mold interior surface, to produce said container;
wherein at least one of said first stage and said second stage produce crystallization of an inner section of the container adjacent to the interior surface.

5. A method of blow molding, in a blow mold having a molding surface, a crystallizable polymer to form a container having an outer section including an outer surface which contacts the molding surface, an inner section including an inner surface which during blow molding is contacted by pressurized gaseous fluid and a middle section intermediate the inner and outer sections, comprising the steps of:
providing a preform of the crystallizable polymer for blow molding the container;
providing the blow mold defining molding surface having a desired temperature;
preheating the preform;
inserting the preform into the blow mold; and
injecting a pressurized gaseous fluid under pressure into the preform to expand the preform into contact with the molding surface, the temperature of the molding surface and the fluid being chosen to crystallize at least one of the inner and outer sections; wherein
the temperatures of the molding surface, the fluid and residence time are chosen to provide a desired variation of crystallization through the inner, middle, and outer sections.

6. The method of claim 5 comprising choosing the temperatures of the molding surface, the fluid and the residence time to provide lower crystallinity in the middle section than in the inner and outer sections.

7. The method of claim 6 comprising choosing the temperatures and, residence time to provide crystallization of the outer section which is higher than the inner section which in turn is higher that the middle section.

8. The method of claim 7 comprising blow molding in first and second stages, in the first stage of which a cool fluid blow is used and in a following second stage of which a hot fluid blow is used.

9. A crystallizable polymer blow molded container having at least a crystallized inner section adjacent an inner surface made by a method of the present invention.

10. The crystallizable polymer blow molded container according to claim 9 wherein crystallinity of a middle section is lower than in inner and outer sections.

11. The crystallizable polymer blow molded container according to claim 9 wherein crystallization of the outer section is higher than the inner section which in turn is higher that the middle section.

12. The crystallizable polymer blow molded container according to claim 9, wherein the container is a multilayer container having at least one barrier layer in the middle section.

13. The crystallizable polymer blow molded container according to claim 12 wherein crystallinity in the middle section is lower than in the inner and outer sections.

14. The crystallizable polymer blow molded container according to claim 12 wherein crystallization of the outer section is higher than the inner section which in turn is higher that the middle section.
